(19) United States
(12) Patent Application Publication
(10) Pub. No.: US 2010/0053983 A1
(43) Pub. Date: Mar. 4, 2010

(54) WARNING LAMP

(76) Inventor: HUNG-CHANG LIU, Lujhou City (TW)

Correspondence Address: PATENTTM.US, P. O. BOX 82788, PORTLAND, OR, 97282-0788, US

(21) Appl. No.: 12/204,740

(22) Filed: Sep. 4, 2008

(51) Int. Cl. B62J 6/00

(52) U.S. Cl. 362/474

(57) ABSTRACT

A warning lamp has a body and a light emitting device. The body has a diaphanous front cover, a rear cover, a chamber and a light reflecting surface. The chamber is formed between the front cover and the rear cover. The light reflecting surface faces the rear cover. The light emitting device is mounted in the chamber and has a circuit board, at least one light emitting element and a power cable. The circuit board has an inner surface and a reflection surface. The reflection surface is formed on the inner surface of the circuit board and faces the light reflecting surface. When the warning lamp operates, the light radiated from the light emitting element can be reflected between the reflecting element and the reflection surface. Therefore, the warning lamp has a wide lighting angular extent.

### BACKGROUND OF THE INVENTION

1. Field of the Invention

The present invention relates to a warning lamp, especially to be a kind of lamp that can be set up handle of a bicycle and warn a car around the bicycle.

2. Description of the Prior Arts

Generally speaking, a bicycle can be installed with a reflector reflecting light radiated from nearby cars to warn drivers in the cars. As the increase in population riding on the bicycle and the rider gradually respect safety, a lot of lamps for bicycles are developed. Nevertheless, the lamp can only illuminate on the front and back of the bicycle without illuminating on two sides of the bicycle. Therefore, with reference to FIG. 5, a warning lamp (40) having a light emitting diode (LED) (41) in accordance with the prior art is mounted on an outside end of a handle (42) of a bicycle in order to warn drivers on left and right sides of the bicycle.

However, the LED (41) has high directional property so the LED (41) can not illuminate for sufficiently large angular extent. Therefore, the warning and lighting effects of the lamp are limited when the lamp is used.

To overcome the shortcomings, the present invention provides a to mitigate or obviate the aforementioned problems.

### SUMMARY OF THE INVENTION

The main objective of the present invention is to provide a warning lamp that can be set up handle of a bicycle and warn a car around the bicycle.

A warning lamp in accordance with the present invention has a body and a light emitting device. The body has a front cover, a rear cover, a chamber and a light reflecting surface. The front cover is diaphanous. The rear cover is mounted around the front cover. The chamber is formed between the front cover and the rear cover. The light reflecting surface faces the rear cover. The light emitting device is mounted in the chamber of the body and has a circuit board, at least one light emitting element and a power cable. The circuit board has an inner surface and a reflection surface. The reflection surface is formed on the inner surface of the circuit board and faces the light reflecting surface of the front cover. The light emitting element is formed on the inner surface of the circuit board. The power cable connects to the circuit board.

When the warning lamp operates, the light is radiated from the light emitting element can be reflected between the reflecting element of the body and the reflection surface of the circuit board. Therefore, the warning lamp can has a wider lighting angular extent than that of conventional warning lamps.

Other objectives, advantages and novel features of the invention will become more apparent from the following detailed description when taken in conjunction with the accompanying drawings.

### BRIEF DESCRIPTION OF THE DRAWINGS

FIG. 1 is an exploded operational perspective view of a warning lamp in accordance with the present invention mounting in a handle of a bicycle;

FIG. 2 is a cross sectional side view of the warning lamp in FIG. 1;

FIG. 3 is a side view of the warning lamp in FIG. 1, showing that the warning lamp is mounted on the a stem of the bicycle;

FIG. 4 is a side view of the warning lamp showing that the warning lamp mounted on a seat lug; and

FIG. 5 is a side view in partial section of a conventional warning lamp in accordance with the prior art.

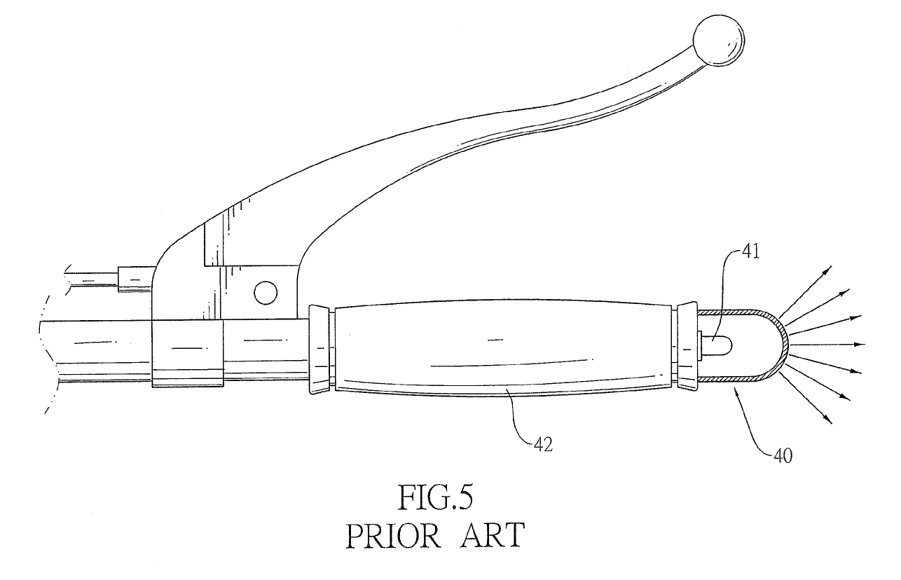

### DETAILED DESCRIPTION OF THE PREFERRED EMBODIMENTS

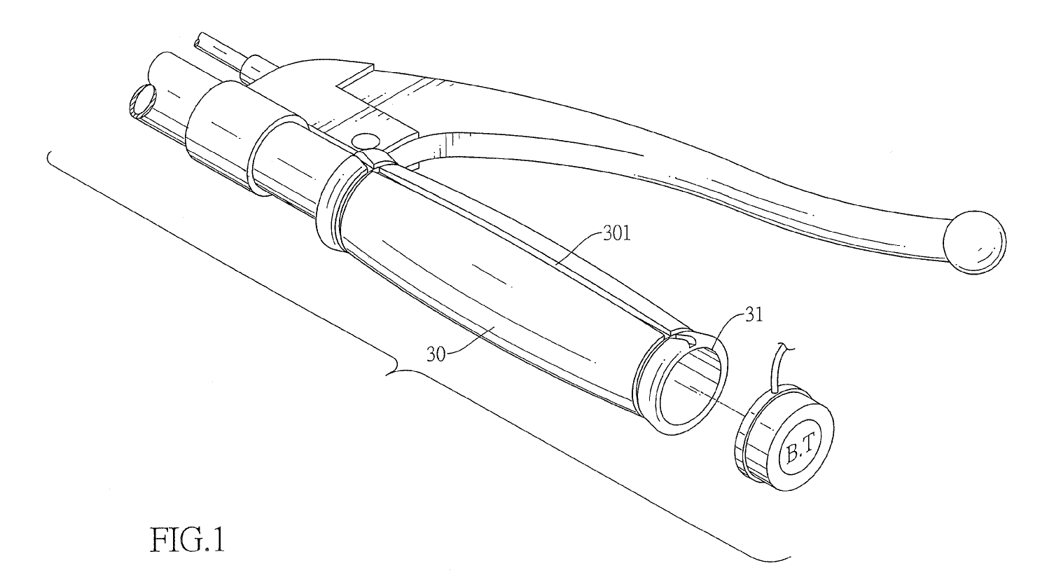

With reference to FIG. 1, a warning lamp in accordance with a present invention is mounted on a distal end (31) on a handle (30) which has a groove (301) being formed on an outer surface of a bicycle and comprises a body (10) and a light emitting device (20).

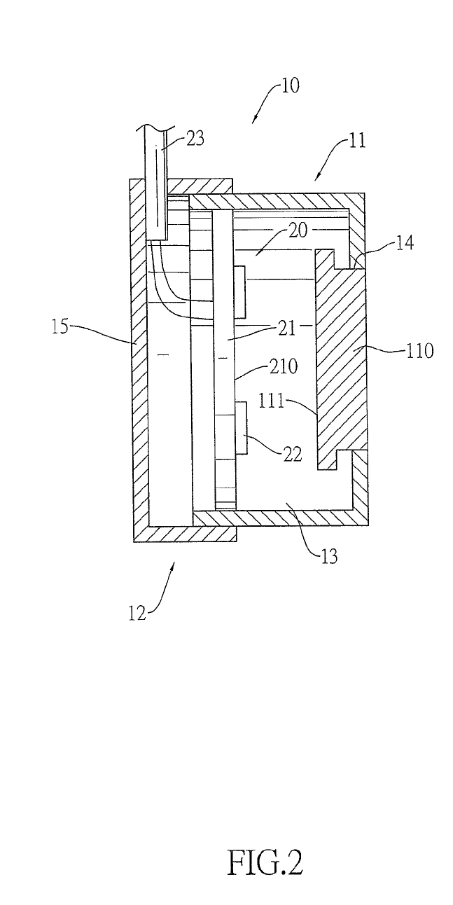

With further reference to FIG. 2, the body (10) has a front cover (11), a rear cover (12), a chamber (13) and a reflecting element (110).

The front cover (11) is diaphanous and has a front wall, an annular sidewall and a mounting hole (14). The mounting hole (14) is formed centrally through the front wall of the body (10).

The rear cover (12) is mounted around the annular sidewall of the front cover (10) and has a back (15) and a through hole. The through hole is defined transversely through the rear cover (12). The back (15) may further have a fastening element in order to set up the bicycle.

The chamber (13) is formed between the front cover (11) and the rear cover (12).

The reflecting element (110) is mounted securely in the mounting hole (14) of the front cover (11) and has a light reflecting surface (111) and outer surface. The light reflecting surface (111) faces the rear cover (12). The outer surface of the reflecting element (110) may has a design to decorate the reflecting element (110).

The light emitting device (20) is mounted in the chamber (13) of the body (10) and has a circuit board (21), at least one light emitting element (22) and a power cable (23).

The circuit board (21) has an inner surface, a circuit and a reflection surface (210). The reflection surface (210) is formed on the inner surface of the circuit board (21) and faces the light reflecting surface (111) of the front cover (11).

The at least one light emitting element (22) is mounted on the inner surface of the circuit board (21) and may be a light emitting diode (LED).

The power cable (23) is mounted through the through hole of the rear cover (12) into the chamber (13) and connects to the circuit of the circuit board (21) in order to control the light emitting element (22).

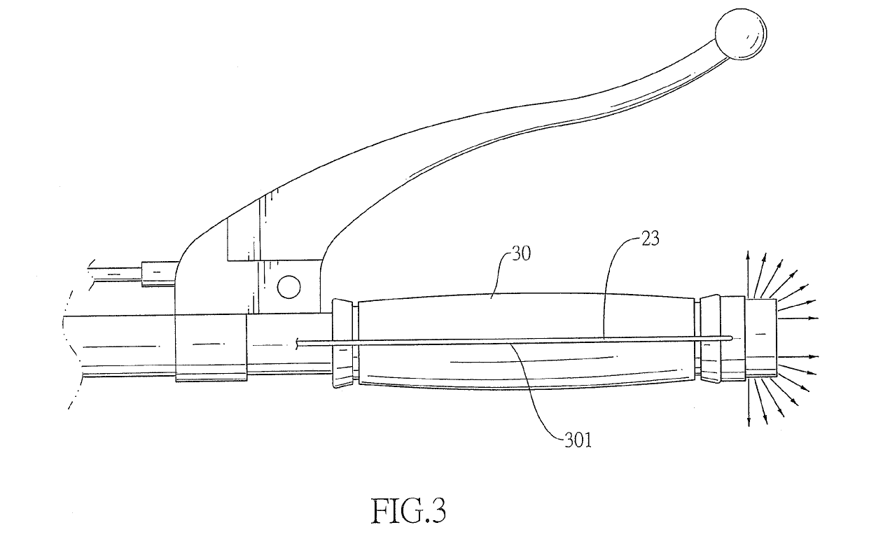

With further reference to FIG. 3, the warning lamp is mounted in the distal end (31) on the handle (30) and the power cable (23) is mounted on the groove (301) of the handle (30) and connect with a main power. The main power may be a battery.

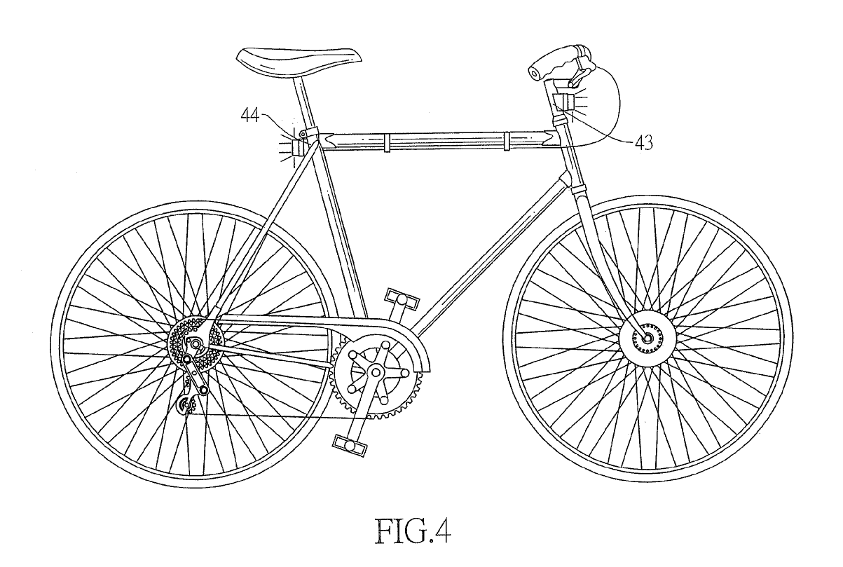

With further reference to FIG. 4, the warning lamp may be mounted on a stem (43) of the bicycle and faces forward or mounted on a seat lug (44) of the bicycle and faces rearward.

When the warning lamp is electrified and operates, the light radiated from the light emitting element (22) can be reflected between the reflecting element (110) of the body (10) and the reflection surface (210) of the circuit board (21). Then, the light evenly diffuses out from front cover (11) of the body (10). Therefore, the warning lamp radiates light for a wider angular extent when compared to conventional warning lamps. Furthermore, because the reflecting element (110) is not pervious to light, the person watching the warning lamp can note a special design having a central dark zone formed from the reflecting element and an annular lighting zone formed from the light emitting element (22) and being around the central dark zone. For this reason the warning lamp have good caution effect.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A warning lamp comprising
a body having
a front cover being diaphanous and having
a front wall;
an annular sidewall; and
a mounting hole being formed centrally through the front wall of the body;
a rear cover being mounted around the annular sidewall of the front cover and having
a back; and
a through hole defined through the rear cover;
a chamber being formed between the front cover and the rear cover; and
a light reflecting surface facing the rear cover; and
a light emitting device being mounted in the chamber of the body and having
a circuit board having
an inner surface,
a circuit; and
a reflection surface being formed on the inner surface of the circuit board and facing the light reflecting surface of the front cover;
at least one light emitting element being mounted on the inner surface of the circuit board; and
a power cable being mounted through the through hole of the rear cover into the chamber and connecting to the circuit of the circuit board.

2. The warning lamp as claimed in claim 1, wherein
the front cover further has a mounting hole being formed centrally through the front wall of the body; and
the body further has a reflecting element being mounted on the mounting hole of the front cover and having an inner surface; and
the light reflecting surface is formed on the inner surface and faces the rear cover.

3. The warning lamp as claimed in claim 2, the light emitting element is a light emitting diode.
